(19) United States
(12) Patent Application Publication
(10) Pub. No.: US 2023/0385864 A1
(43) Pub. Date: Nov. 30, 2023

(54) INTELLIGENT PAIRING SYSTEM FOR ONLINE REVIEW TASKS

(71) Applicants: Hui Ju YANG, Taipei City (TW); Hui-Hsin YANG, Taipei City (TW)

(72) Inventors: Hui Ju YANG, Taipei City (TW); Hui-Hsin YANG, Taipei City (TW)

(21) Appl. No.: 17/946,132

(22) Filed: Sep. 16, 2022

(30) Foreign Application Priority Data
May 26, 2022 (TW) 111205539

(51) Int. Cl. G06Q 30/02

(52) U.S. Cl. CPC G06Q 30/0218; G06Q 30/0282

(57) ABSTRACT

The present disclosure provides an intelligent pairing system for online review tasks which includes a server. The server includes at least a task pairing module and an AI-driven review evaluation module. The task pairing module includes a plurality of task sub-modules, and each task sub-module stores a plurality of online review task items. Each online review task items includes standards and a bonus value. The AI-driven review evaluation module is configured to evaluate whether a submitted review for webpage content meets the standards. If the submitted review meets the standards, the bonus value is awarded to an online bonus account of a task executor.

### CROSS-REFERENCE TO RELATED PATENT APPLICATION

This application claims the benefit under 35 U.S.C. § 119 of Taiwan Utility Model Application Ser. No. 111205539 filed on May 26, 2022, which is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an intelligent pairing system for online review tasks.

### BACKGROUND

The reviews of physical and online stores are often surveyed by the public through the internet. A review generally includes scores and comments. The reviews are accumulated based on the experiences with the stores provided by the public and may reflect the actual quality of said store under normal conditions. However, some large organizations, such as online review companies, may accept tasks to manipulate the review of a specific store or entity. The services provided by these online review companies are generally extremely expensive and therefore are not easily accessible to common individuals.

FIG. 1 illustrates a schematic view of the existing online review dilemma, wherein three ordinary and decent individuals each gave a positive review to the store “petite noodle vendor”, which renders a total review of “3 likes”. However, after a large organization accepted a task from an interested requesting party, a large number of negative reviews (100 dislikes) were given to said store and resulted in a total reviews of −97 points for the “petite noodle vendor”. Therefore, the fairness of the online review system will be compromised. Further, the reputation of the store is unfavorably affected, and on the other hand, the public may be misled by the manipulated review.

Furthermore, in addition to the review in the commercial activities, similar dilemma may occur upon various online information being manipulated by large organizations. Therefore, there is a need to provide an improved online review system as an countermeasure for eliminating or ameliorating the dilemma described above.

### SUMMARY

In order to overcome the undue influence of the large organizations on the internet, general public must be well leveraged with a countermeasure to compete against the large organizations' malicious review manipulations.

As a result, an aspect of the present disclosure provides an intelligent pairing system for online review tasks including a server. The server includes a task pairing module and an AI-driven review evaluation module. The task pairing module includes a plurality of task sub-modules, and each task sub-module stores a plurality of online review task items. Each online review task items includes standards (or requirements, criteria) and a bonus value. The AI-driven review evaluation module is configured to evaluate whether a submitted review for webpage content meets the standards, and if the submitted review meets the standards, the bonus value is awarded to a bonus account of a task executor.

Therefore, an individual A may act as a task assigner and publish a task on the intelligent pairing system of the present disclosure, in which the task includes, for example, giving “likes” on the webpage own by the individual A and a reward will be provided after the task is completed. Another individual B may act as a task executor who accepts the task and “likes” the webpage of the individual A for claiming the reward.

Accordingly, large organizations, such as online review companies, may not monopoly the online review settings by requesting disproportionate consideration, and its undue influence is thus diminished. Because any individual may assign or accept the online review tasks, the online review market power may be preferably balanced.

Other objectives, advantages and novel technical features of the present disclosure will become more fully understood from the following detailed description and accompanying drawings.

### BRIEF DESCRIPTION OF THE DRAWINGS

FIG. 1 shows a schematic view of the existing online review dilemma.

FIG. 2 shows a schematic view of the online review settings anticipated by an intelligent pairing system according to an embodiment of the present disclosure.

FIG. 3 shows a block diagram of an intelligent pairing system according to an embodiment of the present disclosure.

FIG. 4 shows a flow chart for executing a task using an intelligent pairing system according to an embodiment of the present disclosure.

FIG. 5 shows a flow chart for the redemption of bonus value using an intelligent pairing system according to an embodiment of the present disclosure.

FIG. 6 shows a timeline of an intelligent pairing system according to an embodiment of the present disclosure.

FIG. 7 shows a flow chart for the registration of an intelligent pairing system according to an embodiment of the present disclosure.

FIG. 8 shows a flow chart for assigning tasks using an intelligent pairing system according to an embodiment of the present disclosure.

FIG. 9 shows a flow chart for adjusting the assigned task using an intelligent pairing system according to an embodiment of the present disclosure.

FIG. 10 shows a flow chart for recovering the bonus value using an intelligent pairing system according to an embodiment of the present disclosure.

FIG. 11 shows a flow chart for automatically generating a recommendation comment using an intelligent pairing system according to an embodiment of the present disclosure.

FIG. 12 shows a schematic view of recommending tasks using an intelligent pairing system according to an embodiment of the present disclosure.

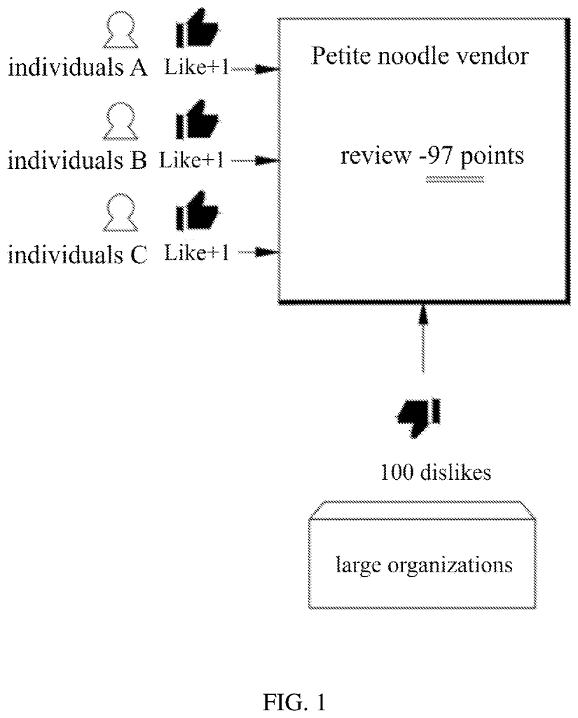

### DETAILED DESCRIPTION

Various embodiments of the present disclosure are provided herein. These embodiments are used to illustrate the technical contents of the present disclosure rather than to limit the scope of the present disclosure. A technical feature of an embodiment may be applied to other embodiments through proper modification, substitution, combination or separation.

It should be noted that in the following description, the meaning of “a”, “an”, and “the” includes plural reference unless the context clearly dictates otherwise.

In addition, in the following description, numbering terms such as “first”, “second” or “third” may be used to describe various components or the like, which are for distinguishing one component from another one only, and are not intended to, nor should be construed to impose any substantive limitations on the components or the like. The term “first” element and the term “second” element may be used in the same component or in different components. An element with larger order number does not necessarily indicate the presence of another element with smaller order number, unless the context clearly dictates otherwise.

In the following description, the so-called “feature A ‘or’ feature B”, or “feature A ‘and/or’ feature B” refers the presence of A only, the presence of B only or the presence of both A and B; the so-called “feature A ‘and’ feature B” refers the presence of both A and B; the terms “including”, “comprising”, “having” and “containing” refer to including but not limited thereto, unless the context clearly dictates otherwise.

Additionally, in the following description, the terms “on”, “under”, “left”, “right”, “front”, “rear” or “between” are used to describe the relative position among a plurality of elements, and may be interpreted into broader meanings including, but not limited to, parallel, rotational or mirroring settings.

Besides, in the following description, the description of “an element is on the other element” or the like does not necessarily suggest that those elements are in contact with each other, unless the context clearly dictates otherwise.

In addition, in the following description, the terms “preferable” or “more preferable” are used to describe optional or additional elements or features, i.e., these elements or features are not essential and may be omitted.

Besides, in the following description, the description of an element “adapted to” or “suitable to” another element indicates that another element does not belong to a part of the subject matter, but to exemplify or to illustrate the feature or application of the element, unless the context clearly dictates otherwise. Similarly, in the following description, the description of an element “adapted to” or “suitable to” a configuration or an action is used to illustrate the feature of the element rather than the configuration having been set or the action having been executed, unless the context clearly dictates otherwise.

In addition, in the following description, the term “system”, “equipment”, “device”, “module” or “unit” refers to an electric component, or a digital circuit, an analog circuit or other circuit with broader definition configured by multiple electric components, and these components do not necessarily have a hierarchical relation therebetween, unless the context clearly dictates otherwise.

Besides, in the following description, the electrical connection between two elements may include direct or indirect connection. In the case of indirect connection, there may be one or more elements, for example, resistance, capacitance or inductance presented therebetween. The electrical connection is for transmitting one or more signals, for example, DC or AC electric current or electric voltage according to actual applications.

In addition, both of the terminal or server may include the above elements or be embodied in the manners described above.

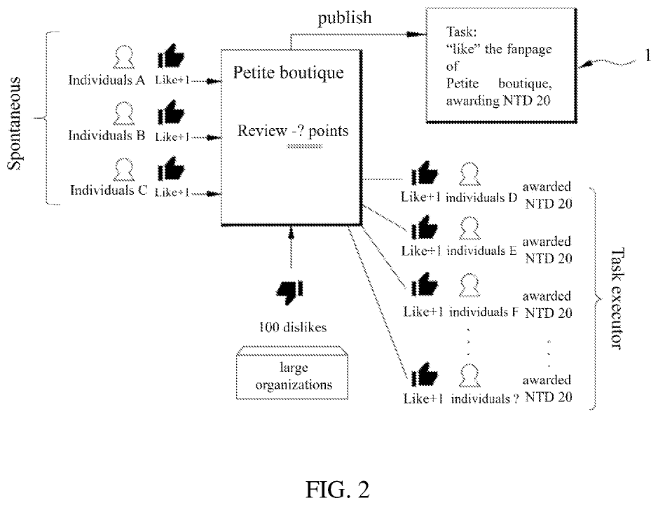

FIG. 2 shows a schematic view of the online review settings anticipated by an intelligent pairing system according to an embodiment of the present disclosure.

Three individuals voluntarily give positive reviews to the store “petite boutique” (3 likes). However, a large organization accepts a task from, for example, an interested requesting party and gives a large number of negative reviews (100 dislikes) to the store. Under such circumstances, as a countermeasure, the owner or employees of the petite boutique may choose to log-in to the intelligent pairing system 1 according to the present disclosure to publish an online review task for recruiting task executor(s) to give “likes” to the store's webpage, and providing a reward of NTD 20 after such task is accomplished.

Therefore, the store “petite boutique” may easily utilize the intelligent pairing system 1 according to the present disclosure to assign tasks and determine an affordable reward to maintain its reputation. A reward of, for example, NTD 20 (under US$1) is sufficient enough to initiate the intension of the individual to accept and carry out such task. Therefore, a monopoly by the online review company may be avoided.

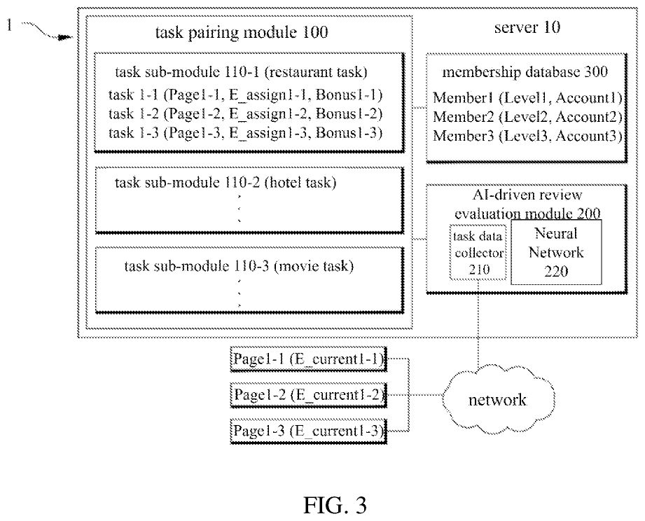

FIG. 3 shows a block diagram of an intelligent pairing system 1 according to an embodiment of the present disclosure.

The intelligent pairing system 1 according to the present disclosure includes a server 10. The server 10 includes a task pairing module 100, an AI-driven review evaluation module 200 and a membership database 300.

The task pairing module 100 includes a plurality of task sub-modules 110, for example, a restaurant task 110-1, a hotel task 110-2 and a movie task 110-3. Each of the task sub-modules 110 stores a plurality of online review task items (Task), each online review task items (Task) includes standards (or requirements, criteria) (E_assign) and a bonus value (Bonus). For example, Task 1-1 requires a task executor to give “likes” on the Facebook fan page of a certain restaurant on Page 1-1 as standards to meet and provides 200 dollar worth of a virtual currency as the Bonus 1-1 after the task is accomplished (i.e. the standards are meet). Task 1-2 requires the task executor to tweet on the public page of Twitter own by a food vendor on Page 1-2 as standards to meet and provides 20 points as the Bonus 1-2 after the task is accomplished (i.e. the standards are meet). Task 1-3 requires the task executor to repost a food review from a blog on Page 1-3 to his/her own Facebook wall as standards to meet, and provides a 20-dollar gift certificates as the Bonus 1-3 after the task is accomplished (i.e. the standards are meet).

Optionally or preferably, the standards (E_assign) may include a “like”, a “dislike”, other emoji, a star rating or a review score by clicking, or a post, a tweet, a review or a suggestion filled-out by inputting, but not to be limited thereto.

Optionally or preferably, the bonus value (Bonus) includes virtual currencies, points, gift certificates, cash, currencies, securities, real objects or virtual treasures. However, the present disclosure is not limited thereto. A member (such as a task executor) may request the intelligent pairing system 1 for cashing-out the bonus value (Bonus), such as the point in their account.

The AI-driven review evaluation module 200 is configured to evaluate whether a submitted review (E_current) for webpage content (Page) meets the standards (E_assign). If the submitted review (E_current) meets the standards (E_assign), the task is flagged as accomplished, and the bonus value (Bonus) is awarded to a bonus account (Account) of a task executor. When a task is accomplished, the AI-driven review evaluation module 200 may update the online review task information accordingly, for example, record the number of tasks that are accomplished for allowing the task assigner to determine if the task may be terminated.

For example, the AI-driven review evaluation module 200 may adopt existing neural network architecture and various webpage content (source code or graphic information) may be fed to the module during the training process for recording the weight or bias of the neuron. Thereby, in the evaluation stage, the result of the online review task (such as whether the designated review, emoji or “like” is presented) may be identified by capturing the webpage content (Page) (source code or graphic information) from the network address according to the network address (such as IP, web address or network address translation, etc.) for the webpage content (Page) recorded by the online review task items (Task).

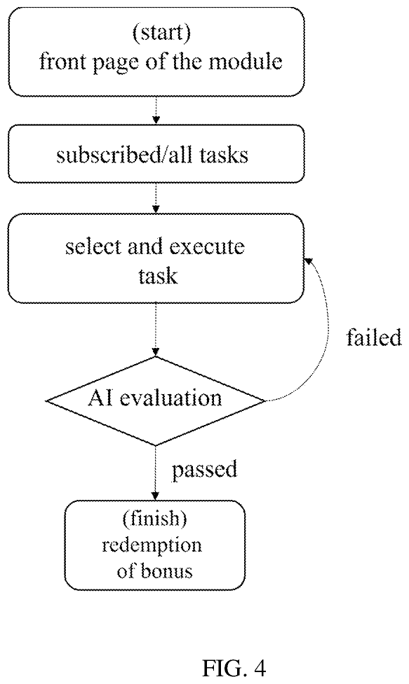

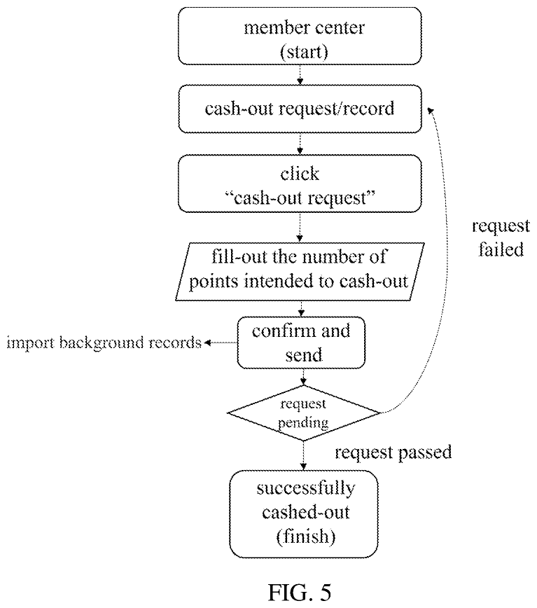

FIGS. 4 and 5 show a flow chart for executing a task and a flow chart for the redemption of bonus value, respectively, using an intelligent pairing system according to an embodiment of the present disclosure. The details of these processes are not reiterated herein because they are specifically illustrated in FIGS. 4 and 5.

Reference is made to FIG. 3. The AI-driven review evaluation module 200 may include a task data collector 210, such as a web crawler, which is a program that is able to automatically capture web contents. The task data collector 210 may be configured to be connected to the network and collect the updated webpage content (Page) from a network address for the webpage content (Page) periodically for allowing the AI-driven review evaluation module 200 to carry out the evaluation described above. For example, the task data collector 210 may collect the webpage contents (Page) before and after the “like” is given for allowing the AI-driven review evaluation module 200 to evaluate if the task executor has given the “like”.

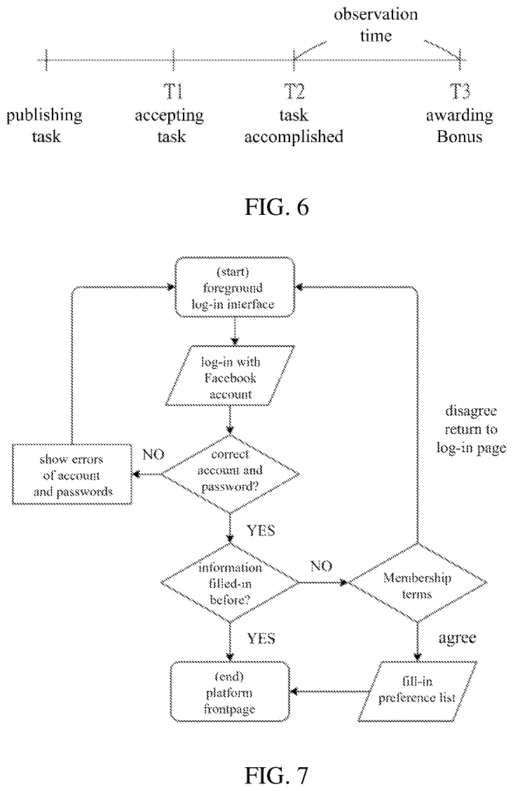

FIG. 6 shows a timeline of an intelligent pairing system 1 according to an embodiment of the present disclosure.

Particularly, to avoid a scenario that the task executor retracts the “like” immediately after obtaining the bonus value or performs other similar actions that compromise the accomplished tasks, the AI-driven review evaluation module 200 may further establish an observation mechanism. Specifically, the AI-driven review evaluation module 200 may be configured to record one of the following time points: (i) a first time point (T1) at which the task executor accepts an online review task associated with the online review task items (Task); (ii) a second time point (T2) at which the task executor accomplishes the online review task for having the submitted review (E_current) meet the standards (E_assign); or (iii) a third time point (T3) at which an observation time is passed after the second time point (T2) at which the task executor accomplishes the online review task.

The AI-driven review evaluation module 200 may evaluate whether the online review task is accomplished based on a notification given by the task executor or based on the updated webpage content (Page) collected by the task data collector 210. However, the bonus value (Bonus) is given to the bonus account (Account) of the task executor by the AI-driven review evaluation module 200 after an observation time, for example, 1 month, is due at the third time point (T3). Generally, because the task executor would likely forget the content of the task or even the existence of such task after a month or so, he/she is unlikely to go back to the designated webpage content (Page) and retract his/her “like”, or carry out other similar actions that compromise the accomplished task.

In addition, the intelligent pairing system 1 of the present disclosure may send an electronic notice stating the assigned number of the online review task and the information related to the award of the bonus value. Optionally or preferably, the electronic notice may delete content of the online review task to avoid the task executor to recall the content of the task, thereby preventing he/she from returning to the webpage content (Page) designated by the online review task and retract his/her “like”, or carry out other similar actions that compromise the accomplished task. Similarly, after accepting an online review task, the task executor may check the content of the online review task stored in the task sub-modules 110, however, the intelligent pairing system 1 of the present disclosure may decline the request for checking the content of the online review task once the task is accomplished.

Regarding the first time point T1 when the task is accepted and the second time point T2 when the task is accomplished, they may be used to manage time sensitive tasks, such as those required to be accomplished before specific date (holiday); or may be used to observe the efficiency of the task executor for performing tasks.

Regarding the management of the membership, the membership database 300 of the server 10 may store a plurality of member profile (Member). Each member profile (Member) corresponds to a task executor or a task assigner. Specifically, the member profile (Member) may be connected to the social media accounts, such as Facebook, Twitter, Instagram, etc. of said member. However, the present disclosure is not limited thereto.

FIG. 7 shows a flow chart for the registration of the intelligent pairing system 1 according to an embodiment of the present disclosure. The detail of the process is not reiterated herein because it is specifically illustrated in FIG. 7.

Reference is made to FIG. 3. Each member profile (Member) may include a credit level (Level). The credit level (Level) may be adjusted (increased or decreased) according to the evaluation of whether the submitted review (E_current) for webpage content meets the standards (E_assign) by the AI-driven review evaluation module 200. For example, a Level 1 private may be promoted to a Level 2 lieutenant after accomplishing tasks within a month. A Level 2 lieutenant may be demoted to a Level 1 private without accomplishing 50 tasks/month, or may be promoted to a Level 3 colonel after accomplishing 100 tasks within a month.

In addition, the task sub-modules 110 of the task pairing module 100 may evaluate whether to grant access to the task executor or the task assigner according to the credit level (Level) thereof. For example, the task sub-module in the category of restaurant may be accessed by a member of any credit level for accepting tasks; the task sub-module in the category of environmental activities may be accessed for accepting tasks by a member of Level 2 lieutenant or higher; and only a Level 3 colonel may act as a task assigner for publishing online review tasks related to environmental activities.

Regarding the concerns of “multiple accounts owned by the same individual”, most of the social media task pairings, such as Facebook, Twitter and Instagram, have the mechanisms for preventing multiple accounts registered by the same individual, such as real-name system, requiring the user to connect a mobile phone number to the account, or detecting any abnormal activities of an account through network addresses (such as IP, web address, network address translation, etc.) or satellite positioning (GPS). Therefore, in the present disclosure, the task data collector 210 may be configured to collect a social media account connected to a member profile (Member), and the AI-driven review evaluation module 200 may be further configured to check whether the social media account is locked, paused or deleted, thereby increase or decrease the credit level (Level) of said member profile (Member). For example, if a task executor uses multiple accounts on Facebook and some of the accounts are identified and locked by Facebook, the credit of the task executor is deemed questionable, and the credit level (Level) thereof may be decreased.

In order to maintain good social morality, the AI-driven review evaluation module 200 of the present disclosure may be configured to evaluate if the online review task items (Task) includes any illegal, dangerous or inappropriate contents. For example, if an online review task requires the task executor to disperse obscene graphics or texts, the AI-driven review evaluation module 200 will prohibit the online review task to be published during a prior examination, or will take down the online review task after publication through a postmortem review.

In the present disclosure, the AI-driven review evaluation module 200 of the intelligent pairing system 1 may further configured to adjust or assign the online review tasks or performing a bonus retracting process according to a customized parameter.

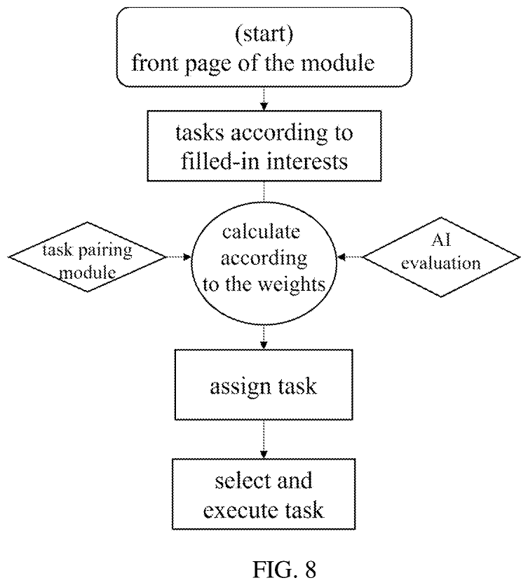

The intelligent pairing system 1 of the present disclosure may further assign tasks to the task executor(s) according to weight(s) through the task pairing module 100 and the AI-driven review evaluation module 200. Reference is made to FIG. 8. FIG. 8 shows a flow chart for assigning tasks using an intelligent pairing system according to an embodiment of the present disclosure. In order words, FIG. 8 exemplifies a flow chart for assigning tasks according to the task weight of a task executor by the task pairing module 100 and the AI-driven review evaluation module 200.

Specifically, the AI-driven review evaluation module 200 of the intelligent pairing system 1 may assign the online review task related of the online review task items (Task) according to a weight resulted from the preference of the task executors. Therefore, the customized parameter may be a weight generated based on the preference of the task executor. In an embodiment of the present disclosure, the task executors may input the type or scope of the task that they are interested in or intend to accept into the intelligent pairing system 1 based on their interests, specialties, preferences and intensions.

For example, after the task executor enters the front page of the task pairing module 100 (after the registration or before the task executor accept a task), the intelligent pairing system 1 may provide tasks including various types or scopes of tasks for the task executor to select. For example, the options provided to the task executor may include, but not limited to, the categories of politics, finance, entertainment, fashion, sports, shopping, vehicles, Internet, technology, consumption, health, financial management, investment, beauty, group purchase, gourmet, movies, medicines, food, games, gossip, travel, transportation, communication, polls and rental, etc. In addition to providing options by the intelligent pairing system 1 for the task executors to select, in some embodiment, the task executor may create and input the type or scope of a task that he/she is interested in or intended to accept.

Next, the type or scope of the task that the task executor is interested in or intended to accept being provided or input by the task executor may be received and processed by the task pairing module 100 and/or the AI-driven review evaluation module 200. The task pairing module 100 and/or the AI-driven review evaluation module 200 perform calculations based on the received information according to weights, thereby provide preferences and references for assigning tasks. Subsequentially, based on the results obtained from the calculations, the task is assigned to the task executor. Therefore, the intelligent pairing system 1 of the present disclosure may assign the tasks in a more efficient manner.

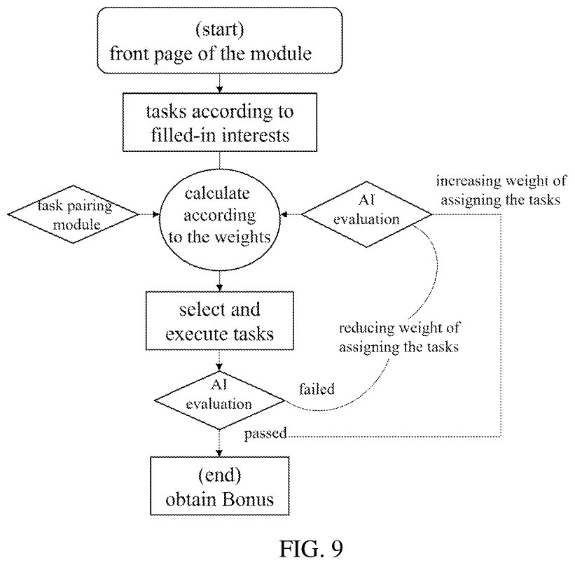

Reference is made to FIG. 9. FIG. 9 shows a flow chart for adjusting the assigned task using an intelligent pairing system according to an embodiment of the present disclosure. In other words, FIG. 9 exemplifies the flow chart for adjusting the weight of assigning tasks according to the evaluation result for the execution of the tasks by the task pairing module 100 and the AI-driven review evaluation module 200.

As shown in FIG. 9, after the task executor selected and executed the task, the task pairing module 100 and the AI-driven review evaluation module 200 may evaluate to increase or decrease the number of tasks assigned to said task executor according to the performance of the task executor in different industries or interested fields. Therefore, the customized parameter may be a task performance score of the task executor. For example, the task pairing module 100 and the AI-driven review evaluation module 200 may evaluate the speed and/or frequency of assigning a following task to the task executor based on the task performance score (for example, an overall performance score obtained by statistics and calculation) of the task executor. Specifically, the AI-driven review evaluation module 200 may evaluate the performance of the task executor, and if the evaluation result (for example, the task performance score) fails to reach a standard or threshold of the task performance, the weight of assigning task will be decreased. On the other hand, if the evaluation result (for example, the task performance score) meets a standard or threshold of the task performance, the weight of assigning task will be increased. Therefore, the efficiency and effectiveness of assigning the tasks may be both optimized.

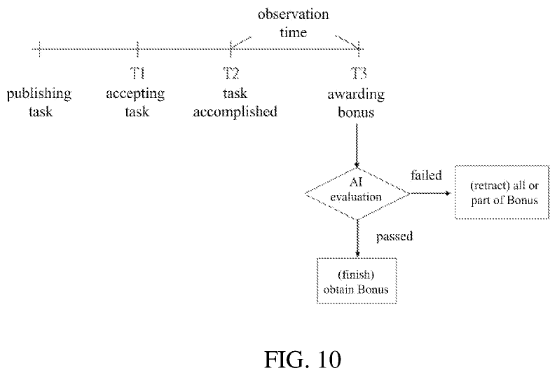

In another embodiment of the present disclosure, the intelligent pairing system 1 of the present disclosure may further include a bonus retracting process. Reference is made to FIG. 10. FIG. 10 shows a flow chart for recovering the bonus value using an intelligent pairing system according to an embodiment of the present disclosure. In other words, FIG. 10 exemplifies the schematic view of the bonus retracting process executed by the task pairing module 100 and the AI-driven review evaluation module 200 of the present disclosure.

Specifically, the task pairing module 100 and the AI-driven review evaluation module 200 may perform a bonus retracting process according to the performance of executing task (task performance score, for example, an overall performance score obtained by statistics and calculation) by a task executor. Therefore, the customized parameter may be the task performance score of the task executor. In the case that the quality of tasks performed by the task executor is poor, the task is finished prematurely, or there are situations that is harmful to the execution of the task, the intelligent pairing system 1 may retract part or all of the bonus value from the bonus account of the task executor.

For example, as shown in FIG. 10, the second time point T2 is the time that the task is accomplished, and the third time point T3 is the time predetermined to award the bonus value to the bonus account of the task executor. At the time point T3, the intelligent pairing system 1 of the present disclosure may evaluate the result of the task executed by the task executor through the task pairing module 100 and the AI-driven review evaluation module 200. If the result passes the evaluation (the result of the execution of the task meets a predetermined standard or threshold), the bonus value is awarded to the task executor; and if the result fails the evaluation (the result of the execution of the task fails to meet a predetermined standard or threshold), a part or all of the bonus value is retracted from the bonus account. Based on the bonus retracting process, the intelligent pairing system 1 of the present disclosure may maintain the quality of the execution of the tasks in a more efficient manner.

In the existing bonus assigning mechanism, the awarded bonus may not be retracted or reduced but merely expired before being cashed out. However, in the present disclosure, the bonus retracting process provides sufficient motivation for the task executor to duly and sufficiently execute the accepted tasks. Therefore, the task may be performed adequately, and the effect of the task may be ensured. Moreover, inadequate task executor may be retired through such mechanism.

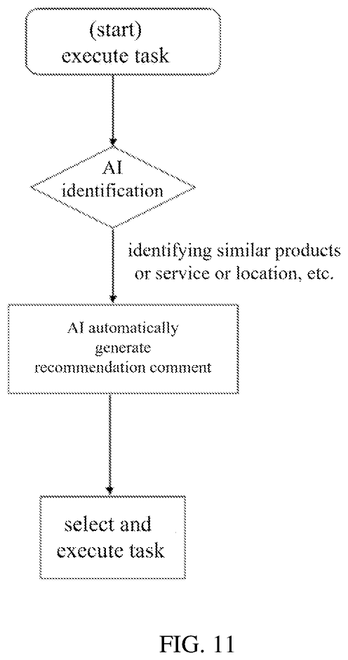

In addition, the intelligent pairing system 1 of the present disclosure may improve the conveniency and the efficiency for executing the task by means of an automation process. Reference is made to FIG. 11. FIG. 11 shows a flow chart for automatically generating a recommendation comment using an intelligent pairing system according to an embodiment of the present disclosure. In other words, FIG. 11 exemplifies the flow chart of identifying and automatically generating a comment through the AI-driven review evaluation module 200 of the present disclosure.

The AI-driven review evaluation module 200 may further execute an automatic recommendation generating process for generate a recommendation comment based on the collected information by means of artificial intelligent. Specifically, the task pairing module 100 and/or the AI-driven review evaluation module 200 may identify similar types of products or service locations to collect related or similar comments or reviews, perform a data process, and thereby generate a recommendation comment automatically by means of artificial intelligent. Therefore, through the intelligent pairing system 1, the task may be executed in a more convenient and efficient manner. As shown in FIG. 11, a recommendation comment is generated automatically through identifying similar products or services by means of artificial intelligent. The task executor may select and execute the task according to the generated recommendation comments.

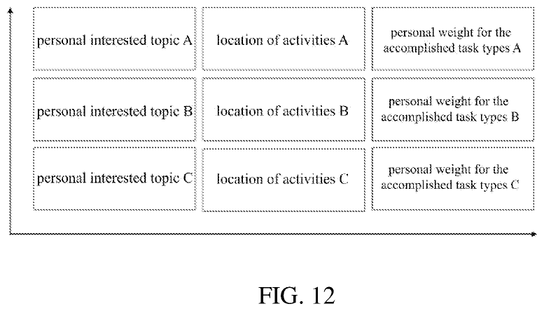

In another embodiment of the present disclosure, the intelligent pairing system 1 of the present disclosure may further include a process for improving the assignment of the task. Reference is made to FIG. 12. FIG. 12 shows a schematic view of recommending tasks using an intelligent pairing system according to an embodiment of the present disclosure. In fact, FIG. 12 illustrates a schematic view in which the AI-driven review evaluation module 200 of the present disclosure recommends tasks according to a personal matrix of a task executor. In this embodiment, the customized parameter is a personal matrix of the task executor.

Specifically, the AI-driven review evaluation module 200 may further recommend or assign online review task according to a personal matrix of the task executor. For example, the intelligent pairing system 1 of the present disclosure may establish a personal matrix according to the preferences, locations or the like of the task executor. As shown in FIG. 12, in the personal matrix, different personal interested topics, location of activities, and the personal weights for the accomplished task types may be included. In the personal matrix, different items have different weights. In the process of assigning the tasks, the task pairing module 100 and/or AI-driven review evaluation module 200 may recommend a proper task to the task executor based on the personal matrix. In other words, based on the recommendation function mentioned above, the efficiency for the task executor to accept tasks is improved and the pairing effect may be optimized.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments, and with various modifications, these embodiments are suited to the particular use contemplated. Alternative embodiments will become apparent to those skilled in the art to which the present disclosure pertains without departing from its spirit and scope.

1. An intelligent pairing system for online review tasks, including:
a server, including:
a task pairing module including a plurality of task sub-modules, wherein each task sub-module stores a plurality of online review task items, and each online review task items includes standards and a bonus value;
an AI-driven review evaluation module being configured to evaluate whether a submitted review for webpage content meets the standards, and if the submitted review meets the standards, the bonus value is awarded to a bonus account of a task executor; wherein the AI-driven review evaluation module includes a task data collector configured to periodically collect updated webpage content from a network address for the webpage content for allowing the AI-driven review evaluation module to execute the evaluation; and
a membership database storing a plurality of member profiles, each member profile corresponding to a task executor or a task assigner and including a credit level; wherein the credit level is increased or decreased according to the evaluation of whether the submitted review meets the standards;
wherein the AI-driven review evaluation module is further configured to record one of the following time points:
(i) a first time point at which the task executor accepts an online review task associated with the online review task items;
(ii) a second time point at which the task executor accomplishes the online review task for having the submitted review meet the standards; or
(iii) a third time point at which an observation time is passed after the second time point at which the task executor accomplishes the online review task;
wherein the AI-driven review evaluation module is further configured to adjust or assign the online review tasks or performing a bonus retracting process according to a customized parameter, and
wherein the task data collector is configured to collect a social media account connected to one of the member profiles, and the AI-driven review evaluation module is further configured to check whether the social media account is locked, paused or deleted, to increase or decrease the credit level of the member profile, and
wherein task submodules of the task pairing module evaluate whether the task executor or the task assigner have access to the task sub-modules according to their credit level.

2. The intelligent pairing system according to claim 1, wherein the standards includes a “like”, a “dislike”, other emoji, a star rating or a review score by clicking, or a post, a tweet, a review or a suggestion filled-out by inputting.

3. The intelligent pairing system according to claim 1, wherein the bonus value includes virtual currencies, points, gift certificates, cash, currencies, securities, real objects or virtual treasures.

4. The intelligent pairing system according to claim 1, wherein the AI-driven review evaluation module is configured to assign the bonus value to the bonus account of the task executor only at the third time point.

5.-6. (canceled)

7. The intelligent pairing system according to claim 1, wherein the AI-driven review evaluation module is further configured to evaluate if the online review task items include any illegal, dangerous or inappropriate content.

8. The intelligent pairing system according to claim 1, wherein the customized parameter is a weight generated according to a preference of the task executor, and the AI-driven review evaluation module is further configured to assign the online review task according to the weight.

9. The intelligent pairing system according to claim 1, wherein the customized parameter is a task performance score of the task executor, and the AI-driven review evaluation module is further configured to adjust the speed and/or frequency of assigning the online review task according to the task performance score.

10. The intelligent pairing system according to claim 1, wherein the customized parameter is a task performance score of the task executor, and the AI-driven review evaluation module is further configured to perform the bonus retracting process for retracting a part or all of the bonus value from the bonus account of the task executor according to the task performance score.

11. The intelligent pairing system according to claim 1, wherein the AI-driven review evaluation module is further configured to execute an automatic recommendation process for generate a recommending review based on collected information by means of artificial intelligent.

12. The intelligent pairing system according to claim 1, wherein the customized parameter is a personal matrix of the task executor, and the AI-driven review evaluation module is further configured to recommend or assign the online review task according to the personal matrix.
